(19) United States
(12) Patent Application Publication
(10) Pub. No.: US 2004/0242293 A1
(43) Pub. Date: Dec. 2, 2004

(54) Customizable play-piece game

(76) Inventor: Lucas McWilliams, Redmond, WA (US)

Correspondence Address: Mark S. Peloquin, PELOQUIN, PLLC, Suite 4100, 800 Fifth Avenue, Seattle, WA, 98104-3100, US

(21) Appl. No.: 10/453,746

(22) Filed: Jun. 2, 2003

(51) Int. Cl. A63F 13/00

(52) U.S. Cl. 463/9

(57) ABSTRACT

An apparatus includes a device and a play-piece for game play. The device enables the user to customize the attributes of the play-piece in preparation for game play. Play-pieces from different time eras can be employed within a given game play scenario.

### BACKGROUND OF THE INVENTION

1. Field of Invention

The invention relates generally to games and game play, and more specifically to apparatuses and methods used to customize game elements and to customizable collectable miniatures games.

2. Art Background

Games have existed in various forms for many years. Card games of various types based on standard 52 card decks are well known. These games are based on rules of play. Each card of the deck represents a unique element, such as “a king of hearts” this attribute of the card is predefined and is assigned to the stock used to make the card during card manufacture. Examples of these games are numerous, and include; “poker,” rummy,” “solitaire,” etc.

Trading cards are well known and have been used to exchange information about public figures and in particular professional baseball players. “Baseball trading cards” contain information particular to the player depicted on the card. Baseball trading cards are typically purchased in retail outlets by enthusiasts who then trade with other enthusiasts in order to complete sets of these cards. Collectors buy and sell trading cards for their economic value. Some of the cards are more common than others, thus rarity of some cards enhance their collectability.

Collectable card games combined aspects of the playing card games and the trading cards by providing rules of play to a variable number of cards. Cards for collectable card games can be purchased and traded among players and the game can be played with variable numbers of cards. Like playing cards and trading cards, the game element (card) is predefined during the manufacture of the card, thus, the attributes of a card do not change with time. An example of a collectable card game is “Magic The Gathering®” by Wizards of the Coast, Inc.

Another type of game, a collectable miniature game is based on the distribution of prepackaged miniature figures according to a rarity system, where some figures are more common than others. Enthusiasts purchase quantities of game play-pieces to broaden their game play experience by increasing the quantity of play-pieces available for game play. The miniatures can be traded amongst enthusiasts to increase the variety of an enthusiast's personal collection. The miniatures can also be purchased and sold as “collectable” items onto themselves, enhanced by the predefined rarity system. Like collectable card games, the game-play attributes of a collectable miniature are predefined during manufacture of the miniature play-piece, thereby limiting the scope of game play possible with the play-piece.

Some of the aforementioned existing games provide fictional settings in which the game is played according to rules of game play. However, these games do not allow players to travel back-in-time on a mission to influence the outcome of historic events; thereby changing the outcome recorded history as is currently known to the players. Additionally, these existing games do not allow for multiple time eras to exist on the play surface simultaneously during game play.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements. In the drawings:

FIG. 1 illustrates customizing the attributes of a play-piece according to one embodiment.

FIG. 2A illustrates one embodiment of play-piece customization.

FIG. 2B illustrates one embodiment of a unit.

FIG. 2C displays a list of symbols and the corresponding attributes according to one embodiment.

FIG. 3A illustrates another embodiment of a unit.

FIG. 3B illustrates a use of a device according to one embodiment.

FIG. 4 illustrates one embodiment of play-piece customization using a stack arrangement.

FIG. 5A depicts another embodiment of play-piece customization.

FIG. 5B shows several units according to one embodiment.

FIG. 6 illustrates one embodiment of a play-piece.

FIG. 7A depicts one embodiment of a play surface.

FIG. 7B illustrates one embodiment of terrain templates.

FIG. 8 illustrates one embodiment of parallel time eras on a play surface.

FIG. 9 illustrates another embodiment for customization of a play-piece.

FIG. 10 illustrates an electronic play surface according to one embodiment.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of ordinary skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

Apparatuses and methods are described to allow a user to customize a play-piece before the start of game play. Thus, a given play-piece can enter game play with a customized set of attributes, predetermined by the user. Game play can exist in different time eras as well as in multiple time eras simultaneously.

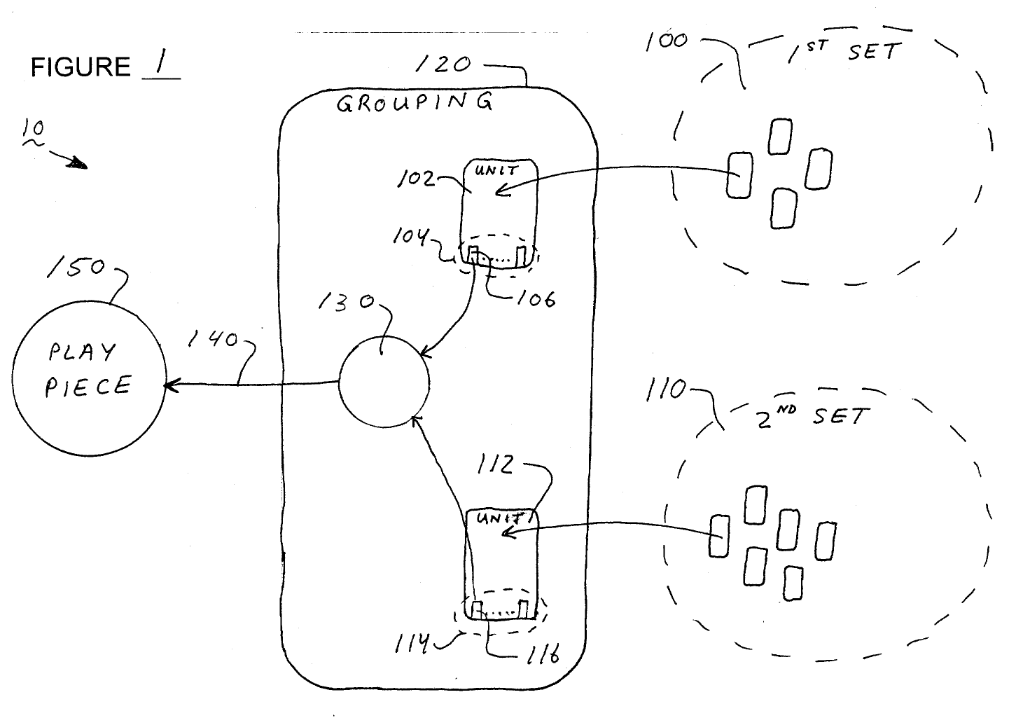

FIG. 1 illustrates customizing the attributes of a play-piece according to one embodiment of the invention. With reference to FIG. 1, customization of a play-piece is shown generally at 10, wherein an attribute of a play-piece is customized by a user. The user can select a unit 102 from a first set of units 100. The unit 102 contains indicia 104 that correspond to attributes to be associated with a play-piece 150. The indicia 104 can be a single indicium or a set of indicia corresponding to attributes to be associated with the play-piece 150. Indicium 106, indicated on the first unit 102 can represent, in one embodiment for example, a range value which can indicate how far the play-piece 150 can fire a weapon. The unit 102 can also set the identity of a character to be associated with the play-piece 150. The user can select a second unit 112 from a second set 110. The second unit 112 contains indicia 114 corresponding to attributes to be associated with the play piece 150. Indicium 116 can correspond to a plurality of different attributes, even an identical attribute addressed by indicium 106 on unit 102, such as a range value which can indicate how far the play-piece can fire a weapon. The first unit 102 and the second unit 112 are grouped as shown within 120. Various apparatuses and methods of grouping will be discussed in the figures that follow. The present invention is not limited by the way in which the units are grouped.

The two indicium 106 and 116 can be mathematically combined at 130 to provide a customized attribute that is associated (as indicated by arrow 140) with the play-piece 150 to allow the play piece 150 to fire a weapon a distance indicated by the addition of indicium 106 and 116. The indicia can be combined according to various methods; the present invention is not limited by the way in which the indicia are combined to provide a customized attribute to the play-piece. For example, in one embodiment indicia 104 and indicia 114 can be combined by the user when viewing unit 102 and unit 112 together. In such a grouping of unit 102 and unit 112, the user mathematically combines indicium 106 and indicium 116 together mentally to produce the composite “value” for the attribute that is associated with the play-piece 150. This customized attribute is associated with the play-piece 150 and is used by the user during game play.

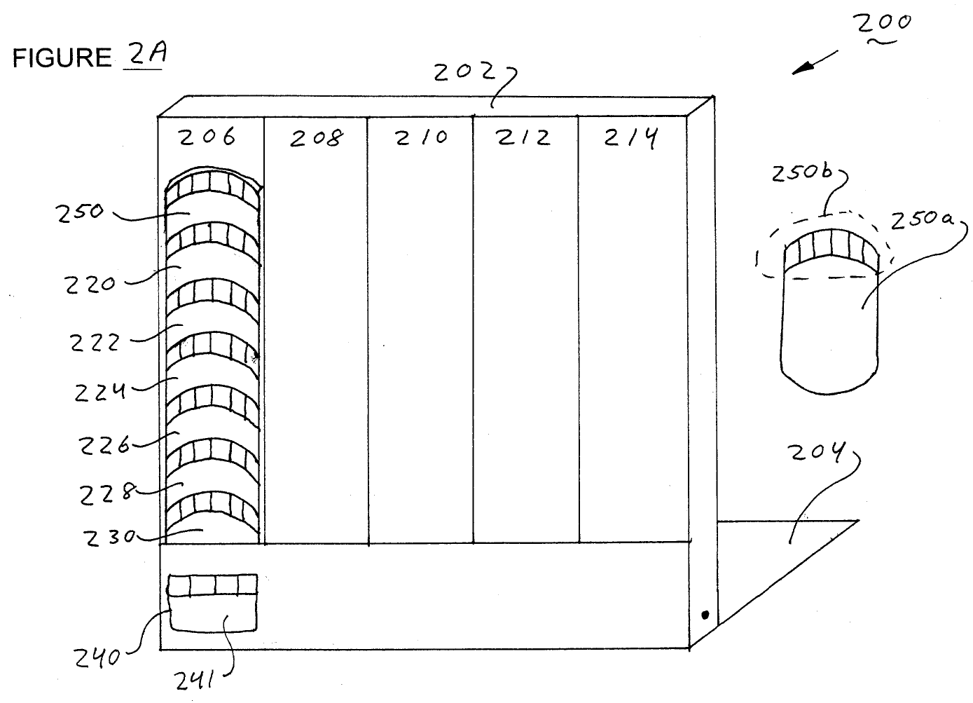

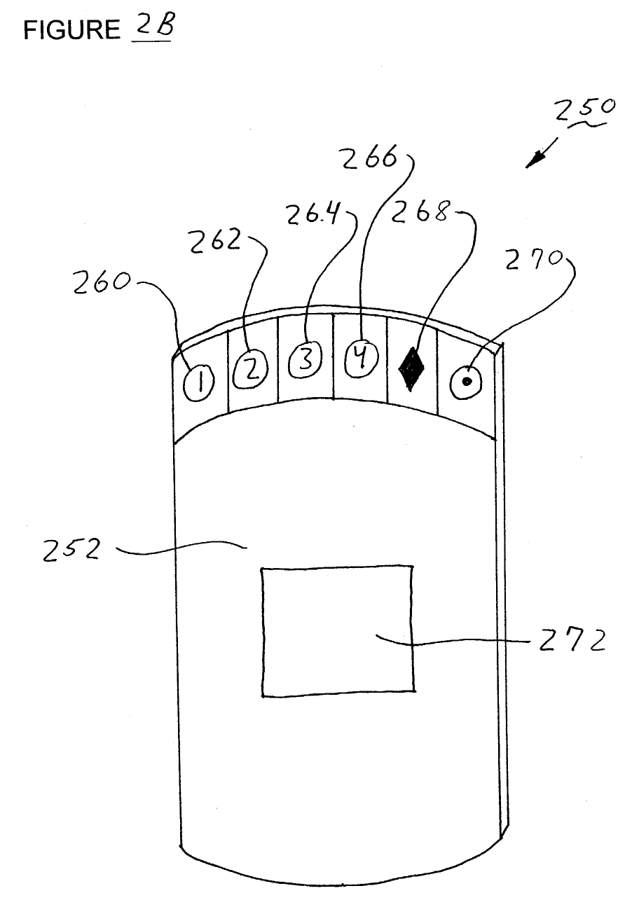

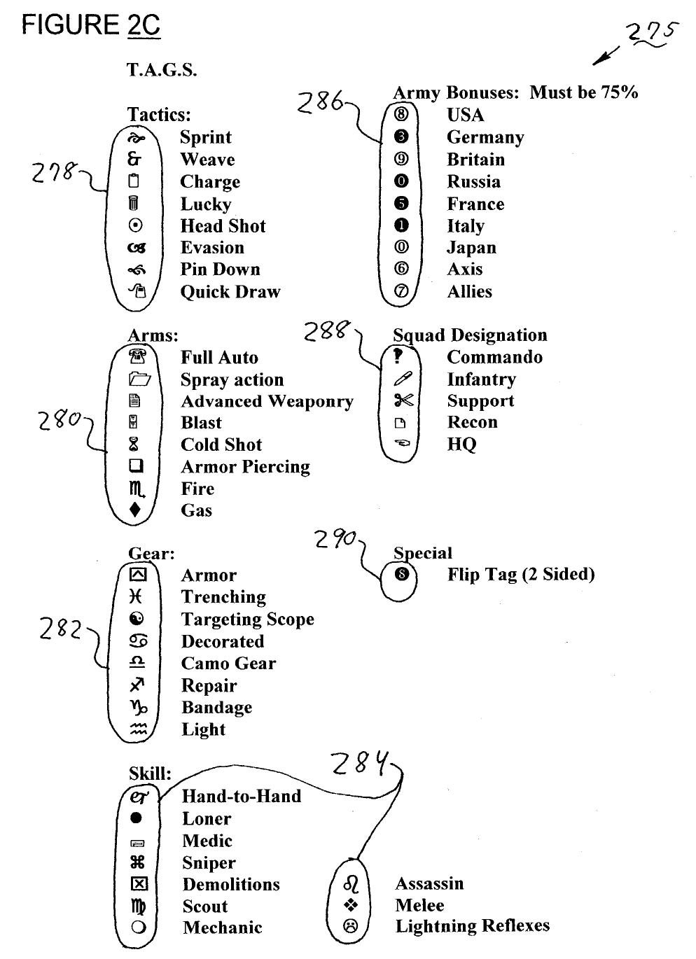

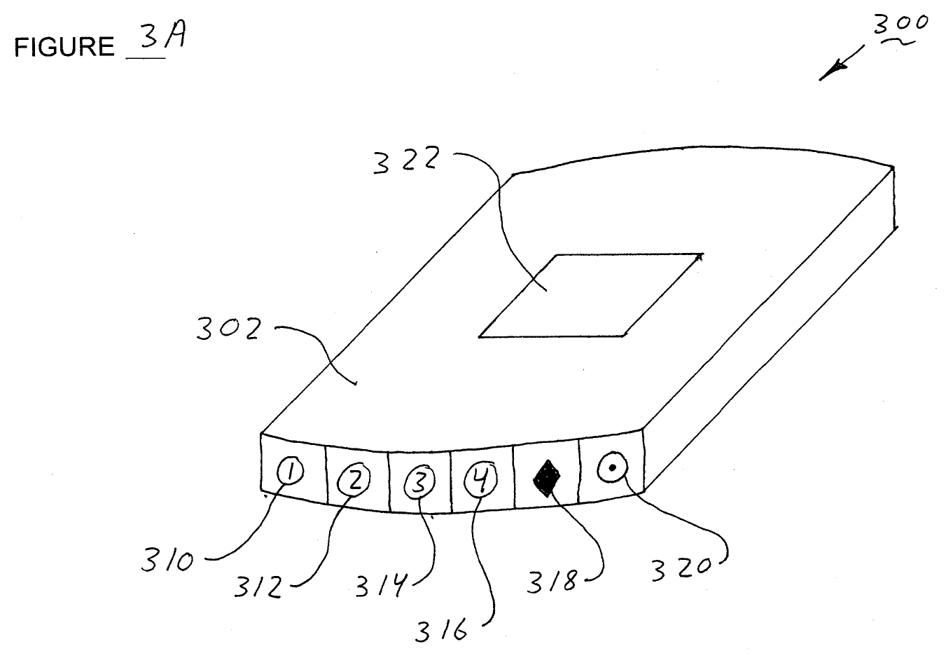

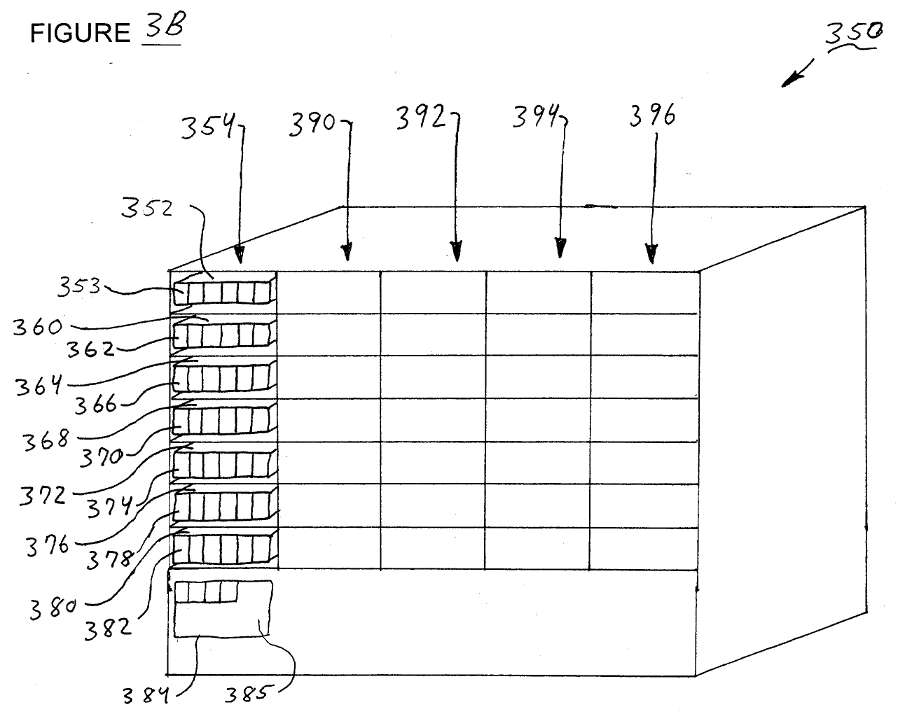

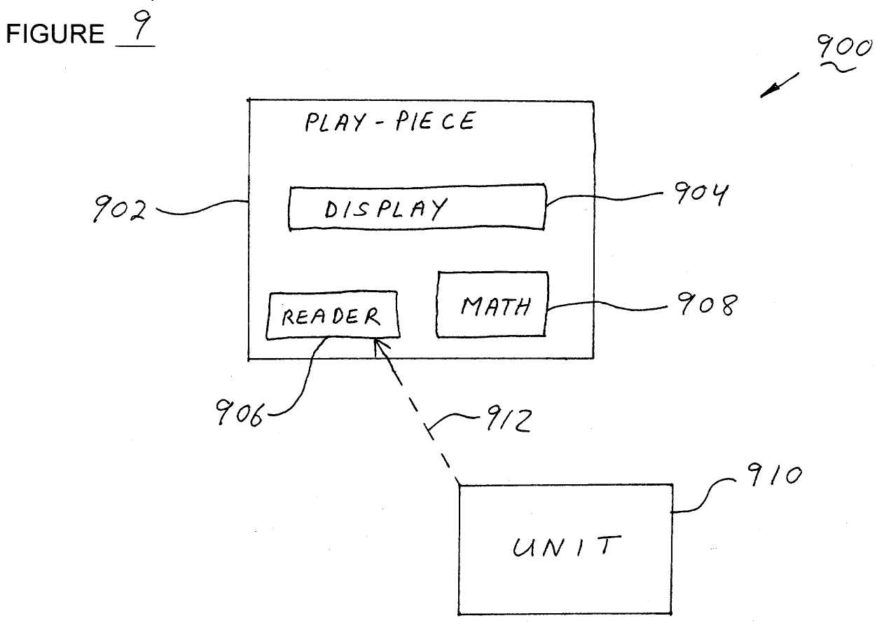

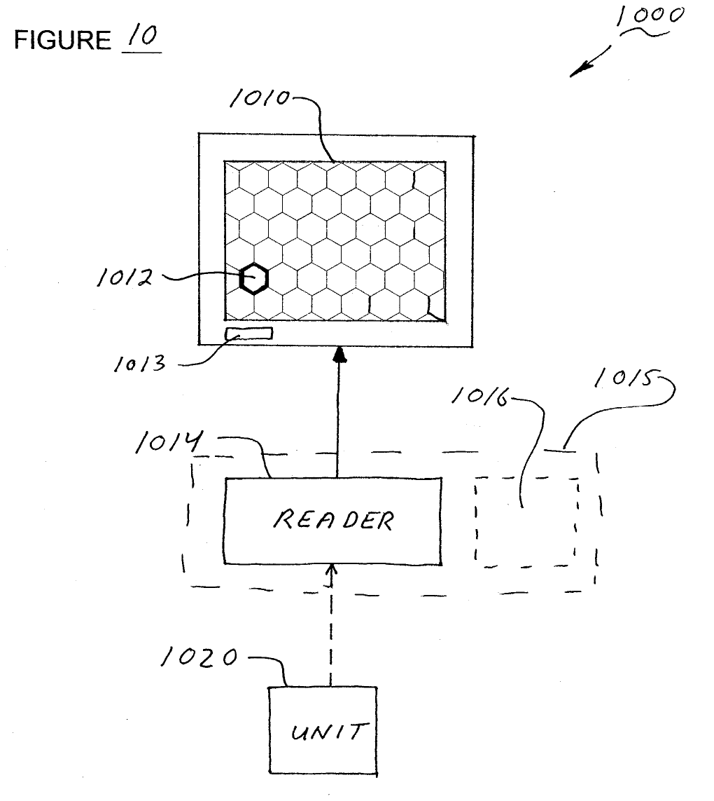

In another embodiment, the mathematical combination 130 can occur electronically or mechanically as discussed more fully below in conjunction with FIG. 2A, FIG. 3B, FIG. 9 and FIG. 10. The present invention is not limited by the way in which the attributes of the play-piece are customized.

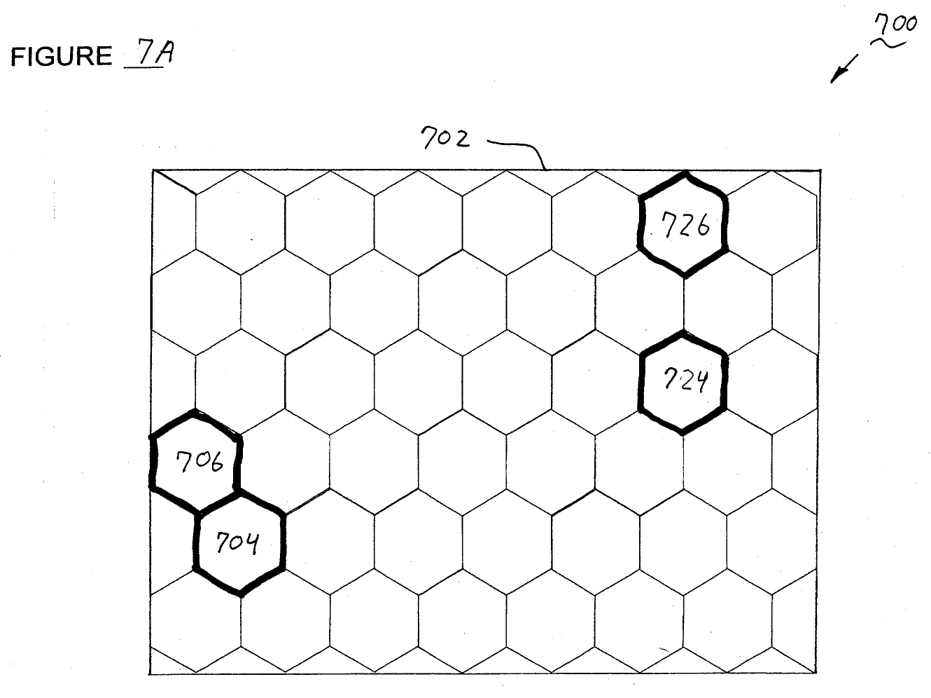

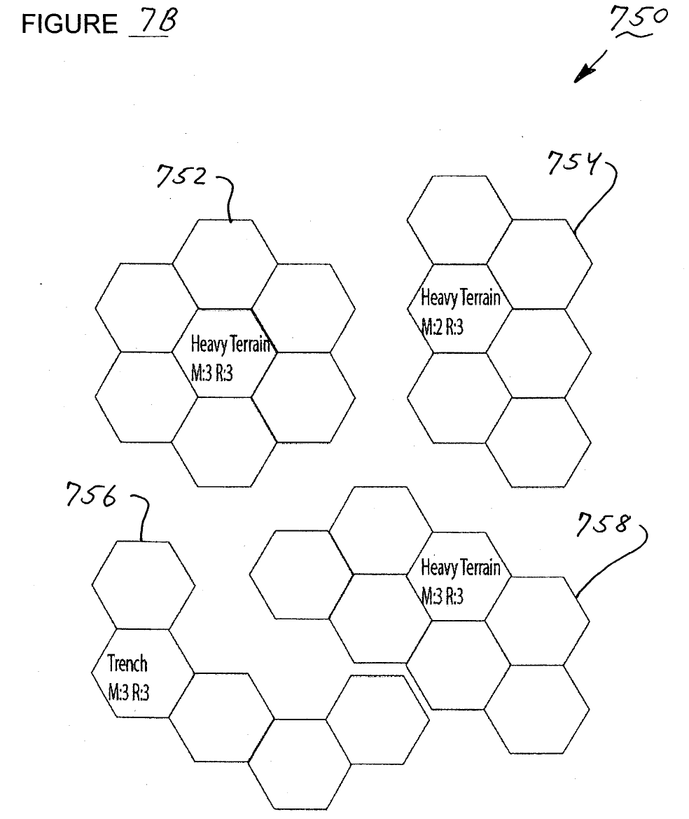

FIG. 2A illustrates one embodiment of play-piece customization using a device to group units indicated generally at 200. With respect to FIG. 2A, a device 202 is shown with five vertical columns indicated by 206, 208, 210, 212, and 214. Device 202 can be configured as a tray, a rack or a card sleeve. In this embodiment, each of the five columns is associated with a different play-piece and each column is capable of holding seven units. The selection of seven units per play piece is an arbitrary choice and represents one embodiment adapted to game play with six-sided dice that will be described below in conjunction with FIG. 7A. In general, the number of units assignable to a play-piece is arbitrary and those of ordinary skill in the art will recognize other constructions that are possible within the teaching herein.

The units can be made in any shape desired and can be made to resemble known objects. In conjunction with several of the figures herein and the battle-game-play theme, units can be made in the shape of a “dog tag” such as a unit shown at 250a. Other shapes and styling may be applied to make a unit resemble a computer chip, a paper card, a credit card, a coin, etc. The aforementioned list of unit shapes is not exclusive; the shape and resemblance of a unit is to be given broad interpretation within the context of the teaching presented herein.

For clarity in the illustration (FIG. 2A), only column 206 is populated with units. Column 206 is populated with seven units indicated by 250, 220, 222, 224, 226, 228, and 230. Any one of the units located in column 206 can be represented as the unit shown at 250a. Indicia are arranged on the units, as shown on 250a, with six locations indicated by the horizontal array of squares indicated generally at 250b. Six locations for indicia is an arbitrary choice, the present invention is not limited by the number of indicia contained on the unit. Those of ordinary skill in the art will recognize that another number of indicia could have been selected. The “six locations for indicia” are not related to the “six units” selected to contribute to the magnitude of the attribute associated with the play-piece. Any number of indicia could have been displayed on the unit 250a. The units contained in column 206 are arranged to be viewed by the user and the indicia can be mathematically combined by the user to ascertain the magnitude of the attribute associated with the play-piece.

No limit is implied by the location of the indicia on or in the unit. In one or more embodiments, the indicia will be represented as data to be read by electronic means by a data processing system. The units can be configured to interact with and to be read by the device 202 so that the indicia from each unit are mathematically combined either, electronically or mechanically. The mathematical combination of the indicia is then displayed in data display 240 for column 206. Region 241 of display 240 can be used to display symbols that are described below in conjunction with the figures that follow. The indicia listed on the units can be combined according to mathematical operations that are well known in the art and need not be limited to addition. As is well known by those or ordinary skill in the art, an indicium can take on a negative value which implies subtraction of one value from another. No limitation is implied by use of the term “mathematical combination,” it is intended to encompass a broad interpretation when applied herein.

FIG. 2B illustrates one embodiment of a unit shown in more detail generally at 250. With reference to FIG. 2B, indicia are located on a surface 252 of the unit 250. Numerical values are inserted into the first four indicium locations e.g., 260, 262, 264, and 266. Symbols indicated by reference numeral 268 and 270 are located in the fifth and sixth indicium locations. The symbols indicated by reference numerals 268 and 270 impart attributes to the play-piece and add to the customization of the play-piece. Other information associated with a play-piece or more generally with a group of play-pieces can be located on the unit. An example of such other information is the region indicated at 272.

FIG. 2C displays at 275 a list of symbols and the corresponding attributes that may be implied by the symbols. “Special ability” is a term that can be used synonymously with an attribute that corresponds to a symbol. No limitation is implied by the use of the term symbol or special ability and both terms will be used interchangeably throughout this description. With reference to FIG. 2C, in one embodiment adapted to a battle-game-play theme of a particular time era, the symbols can be categorized by tactics, arms, gear, and skill, hence the acronym T.A.G.S. Other categories are shown under the headings “Army Bonuses,” “Squad Designation,” and “Special.” The symbols associated with “tactics” are shown at 278 and include such tactics as are applicable to battle or army combat scenarios of game play. The symbols associated with “arms” are indicated at 280 while the symbols associated with “gear” are shown at 282. Similarly, the symbols associated with “skill” are shown at 284. Any number of symbols can be included in these groupings as shown in FIG. 2C. 286, 288, and 290 indicate other symbols. The groupings shown are indicative of one or more embodiments of the invention; no limitation is implied thereby.

The symbols shown in FIG. 2C are adapted to the historical setting of World War II. Other groups of symbols can be tailored to other historical settings as is appropriate. The present invention is not limited to any particular historical setting. It is readily contemplated that the teachings presented herein will be applied broadly in theme and time era. For example, some other battle-game-play themes are, but are not limited to, World War I, the Korean War, the Vietnam War, the wars in Iraq (Desert Storm/Shield), the war in Afghanistan, the Revolutionary War, the Civil War, etc. Symbols can be adapted as appropriate to past or future fictional settings; some examples are, but are not limited to, computer lab assault, battle for Mars, etc.

As mentioned previously, play-pieces from different time eras can be customized for game play within a single game play session. In such a multi-time era setting the list of symbols shown in FIG. 2C would encompass those symbols necessary to accommodate the multiple time eras active within the game.

FIG. 3A illustrates another embodiment of a unit used to customize a play-piece. With reference to FIG. 3A, a unit 300 is shown with indicia located on an edge of the unit and on a surface 302 of the unit 300. For consistency and ease of understanding, the same numerical values have been used for the indicia in both FIG. 2B and FIG. 3A; however, the choice of numerical values for the indicia is completely arbitrary, no limitation is implied by the use of the values shown in the figures. In one embodiment, consistent with the battle-game-play theme, the numerical values can be associated with attributes of the play-piece in the following way. Indicium 310 can correspond with a range value which indicates how far a play-piece can fire a weapon. Indicium 312 can correspond to a damage value which indicates how much damage will be inflicted on an opponent's play-piece if the opponent's play-piece is hit. Indicium 314 can correspond with an attack value, and indicium 316 can correspond to a defense value. The correspondence between indicia and attributes is arbitrary and those of ordinary skill in the art will readily observe other correspondences that are possible. All such variations are within the contemplated implementations of the present invention. No limitation is implied by the correspondences chosen for this illustration.

Additional information can be incorporated into the unit 300; such an area for additional information is shown at 322; however, information can be incorporated anywhere on the unit 300, 322 is not limiting in any way. Additional information is, but is not limited to, a point value for the unit, a picture or word indicating the type of gear represented by the unit, a word corresponding to one or more of the symbols on the unit (if the unit contains a symbol), a character identity to be ascribed to the play-piece, a color of the unit, and an orientation of the unit. For example, in one embodiment, four colors; black, green, brown, and grey can convey attributes to a play-piece thereby contributing to the customization thereof.

FIG. 3B illustrates a use of a device according to one embodiment of the invention. With reference to FIG. 3B, a device used for grouping units is shown generally at 350. In one embodiment, the device 350 is a box. Similar to the device 200 shown in FIG. 2A, the device 350 (FIG. 3B) is arranged with five columns indicated at 354, 390, 392, 394, and 396. The choice of five columns is arbitrary and was selected so that the device 350 could be used with five play-pieces according to one embodiment of the invention that will be described below in conjunction with FIG. 7A. The unit 300 (FIG. 3A) can be represented as 352 inserted into the device 350, and a first indicium indicated by 353 can correspond to indicium 310 (FIG. 3A). Likewise additional units are inserted into the slots in the column 354. Unit 360, unit 364, 368, 372, 376, and unit 380. The device 350 groups the units by column so that a user can view the indicia: in this example, the indicia are indicated at 353, 362, 366, 370, 374, and 378. The numerical values that the user sees at these locations are mathematically combined by the user to ascertain the magnitude of the attribute to be associated with the play piece associated with the first column of units.

In one embodiment, utilizing color to augment the customization of a play-piece, black, green, brown, and grey can be used to convey special attributes to the play-piece. The choice of colors contained herein is arbitrary and another combination of colors can be used, no limitation is implied by the choice of colors used in this description. A color such as Black can be used to describe units whose indicia are combined as described above in conjunction with FIG. 3B. A color such as grey can be used to indicate a unit used to identify a play-piece. The grey unit can also contain starting indicia to be associated with the play-piece. A color, such as green, can be used to indicate a one-use unit that needs to be activated by a user. One method of activating a one-use unit is to declare its activation by oral announcement during game play. A one-use unit can be double sided; therefore, after the unit is used to provide temporary customization of the play-piece the user flips the unit over to indicate that the unit is no longer available for use in game play. A color, such as brown, can be used to indicate an override unit. In one embodiment, an override unit needs to be activated during game play. Once activated, the override unit overrides the operative mathematical combination of indicia making up the attributes associated with the play-piece. In one embodiment, the override unit does not override the indicia of the grey unit described above that establishes the identity of the play-piece.

In another embodiment, the units can be configured to be read by a mechanism within the device 350, similar to the configuration described in conjunction with FIG. 2A, so that the indicia are mathematically combined either electronically or mechanically and the result displayed on a display 384. As in the discussion directed to FIG. 2A, the display 384 can be configured with a region 385 to display the symbols (if any) existing on the units that pertain to the play-piece associated with column 354. Other displays (not shown) can be provided to display the attributes associated with other units (not shown) that would be inserted into columns 390, 392, 394, and 396.

Both devices shown in FIG. 2A (device 200) and in FIG. 3B (device 350) can be used to associate attributes with play-pieces according to a variety of ways utilizing different rules of game play. For example, according to one embodiment, a single column can be identically associated with a single play-piece. According to another embodiment, a single column can be associated with a plurality of play-pieces. Rules of game play can be adapted to both associations. The five column arrangement shown in both the device (FIG. 2A) and the device (FIG. 3B) allows the user to form a squad of five play-pieces, for example, a play-piece being represented by a soldier (as well as other entities) in the context of the battle-game-play theme. It is not required that all five columns be utilized by a user during game-play, no limitation is implied by the number of columns utilized in the devices shown in the figures.

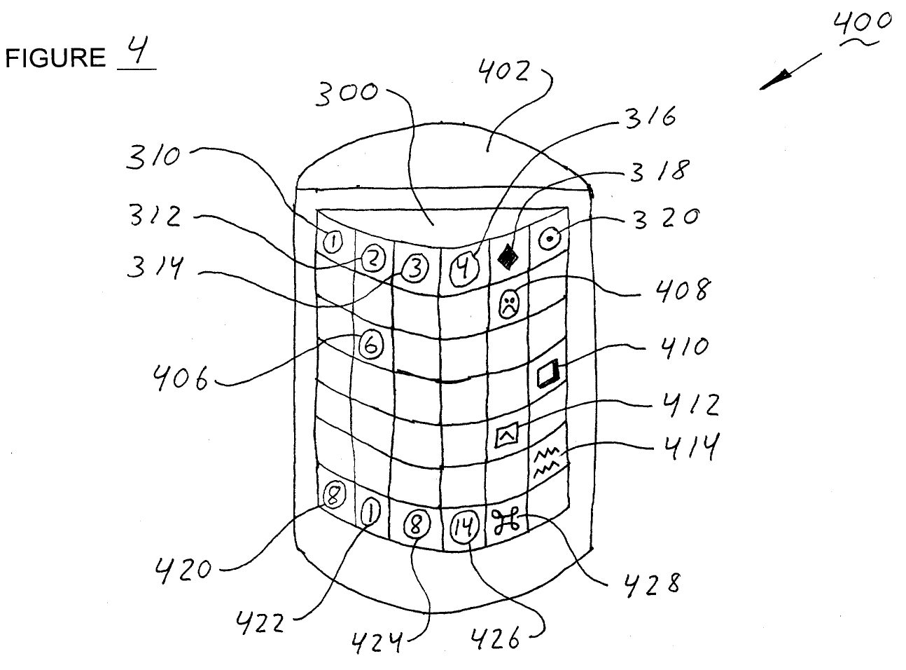

FIG. 4 illustrates one embodiment of play-piece customization using a stack arrangement. With reference to FIG. 4, a device is shown generally at 400. A device 402 holds a plurality of units arranged in a vertical stack. In one embodiment device 402 is a unit dispenser. In other embodiments, the stack can be configured to be horizontal. A first unit that would be selected by a user, unit 300 (FIG. 3A), is shown inserted into the device 402. The user selects a second unit and the unit is inserted into device 402; thereby configuring a play-piece with “lightning reflexes” as indicated by 408 with reference back to the symbols in group 284 (symbol meaning taken from FIG. 2C). A third unit has been selected and placed in the device that provides damage of six as indicated by 406 (symbol meaning taken from FIG. 2C). A fourth unit, containing symbol 410, configures the play-piece with Armor piercing capability (symbol meaning taken from FIG. 2C). A fifth unit provides the play-piece with armor at 412 (symbol meaning taken from FIG. 2C). A sixth unit configures the play-piece with a light indicated by 414 (symbol meaning taken from FIG. 2C). The seventh unit on the bottom of the stack configures the play-piece as a sniper as indicated at 428 (symbol meaning taken from FIG. 2C) and provides attributes 420, 422, 424, and 426. Alternatively, the units could have been selected in another order, no limitation is implied thereby.

According to one embodiment, the magnitude of the attributes of the play-piece are determined by mathematically combining the numerical values indicated by the indicia contained on the units by summing the numerical values in each column. In the battle-game-play theme, the first column can represent the range value of a play-piece, summing the number represented by 310(1) and the number represented by 420(8) provides a range value of 9 which is associated with the play-piece. Similarly, summing the number represented by 312(2) with the number represented by 406(6) and with the number represented by 422(1) results in 9 for a damage value. Likewise the third column is summed by adding the number represented by 314(3) with the number represented by 424(8) to provide an attack value of 11. The defense value is found by summing 316(4) with 426(14) to yield 18.

A different selection of units would result in a different configuration for the play-piece at the start of game play. The user is free to select units and to customize the play-piece as desired for the time era and mission that is the subject of game play. Missions will be described below in conjunction with FIG. 7B.

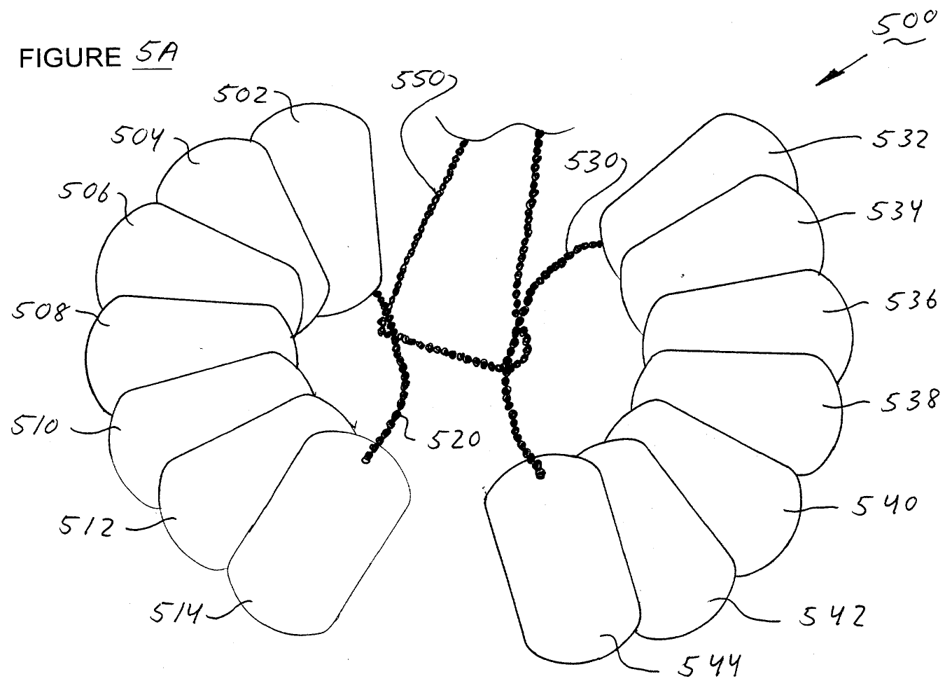

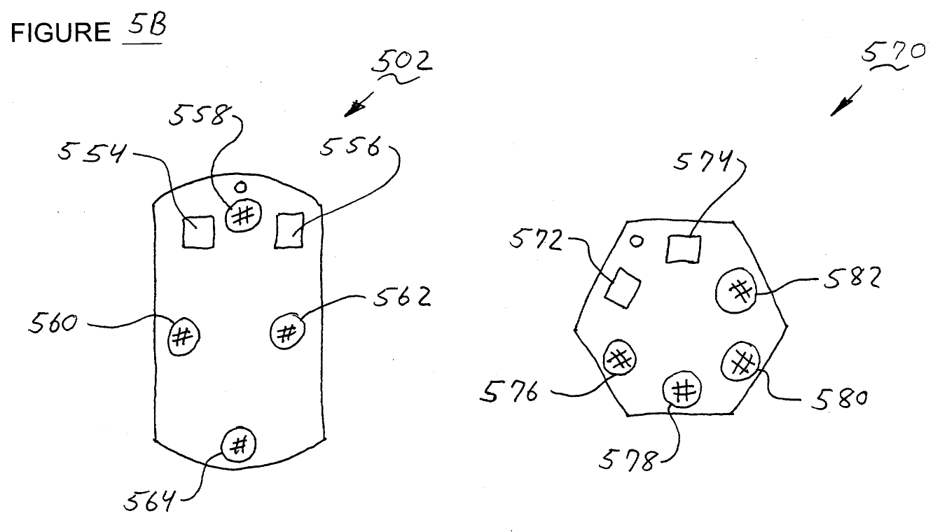

Alternative groupings of units are possible within the context of customizing a play-piece for a particular time era and mission. FIG. 5A shows two groups of units grouped together using a device. With reference to FIG. 5A, units 502, 504, 506, 508, 510, 512, and 514 are grouped using a device 520. Device 520 can be a flexible member. This group can correspond to the arrangements of units previously described in conjunction with FIG. 2A, FIG. 3B, and FIG. 4. Another group of units indicated by numerals 532, 534, 536, 538, 540, 542, and 544 are grouped on device 530. Each group of units on device 520 and on device 530 can be associated with a different play-piece. The individual devices 520 and 530 can be grouped with a device 550 to organize the units corresponding to the play-pieces that makeup a group of play-pieces. Another term for a group of play-pieces in the context of the battle-game-play theme is a “squad.” The flexible members can be made from any convenient material such as a chain, string, yarn, rope, wire, etc. No limitation is implied by the material used for the flexible member.

FIG. 5B illustrates two embodiments of a unit adapted to the method of grouping illustrated in FIG. 5A using flexible members. With reference to FIG. 5B a unit is shown generally at 502. Symbols or indicia representing special abilities can be indicated at locations 554 and 556. Numeric indicia can be located at 558, 560, 562 and 564. Alternatively, the shape of the unit could be hexagonal as shown at 570 (FIG. 5B), with symbols located at 572 and 574 and numeric indicia located at 576, 578, 580, and 582. The aforementioned six locations in 502 and 570 provide for six indicia corresponding to attributes to be associated with a play-piece during game play as described in conjunction with FIG. 2A (device 200), FIG. 3B (device 350), and FIG. 4. Thus, it can be readily observed that the shape of the unit is variable and is not confined to limited geometries. As was mentioned earlier, the unit can contain indicia in the form of data that are used to customize the play-piece according to embodiments taught herein.

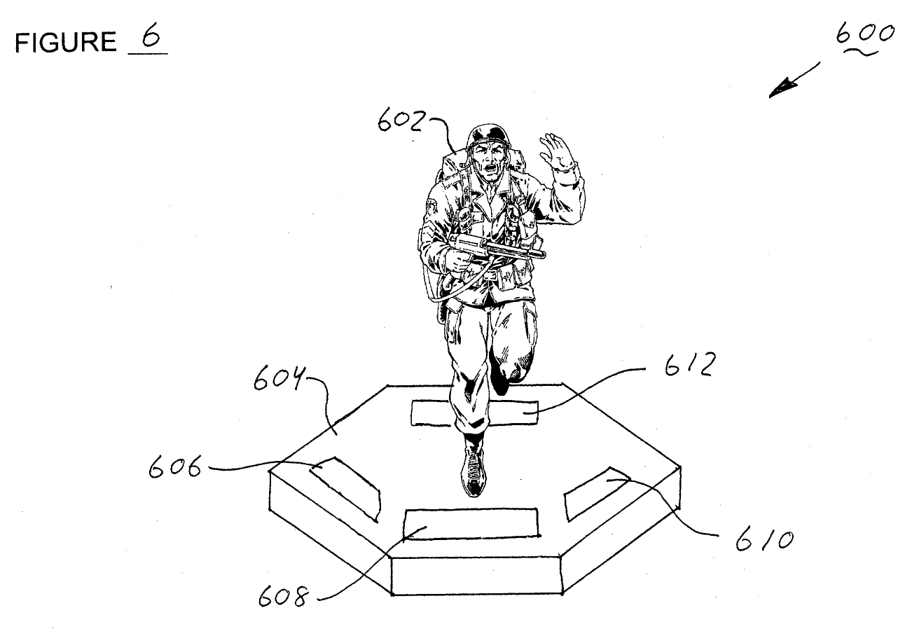

FIG. 6 illustrates one embodiment of a play-piece. With reference to FIG. 6, a play-piece is illustrated generally at 600. The play-piece 600 is in the shape of a miniature character 602 and a base 604. The miniature character 602 follows the battle-game-play theme. Many different characters can be created within a given game-play theme. There is no limit to the number of characters that can be provided in a game-play theme within the context of the present invention. A number of 100 characters presents consumers with a desirable number that makes game play both fun and full of interesting variation; however, numbers both greater than 100 and less than 100 are equally valid numbers of characters; no limitation is implied by the number of characters.

Miniature character 602 can be produced in a quantity that varies from a quantity that another character is produced in, thus making one character rarer than another. Rarity can also be established by painting the same character differently; thereby creating sought after colors within a given character sculpt. Another variation in the play-piece that creates rarity is to use the same character sculpt on bases of different shapes. For example, the same character sculpt could be mounted on a hexagonal base, a round base or a square base. Such rarity enhances the collectability of the characters and enhances the play value and the economic value of the characters.

Miniature character 602 is mounted on a hexagonal base 604 that has information personal to the character printed thereon. In one embodiment, an example of such information is, but is not limited to, the figure's name, the collector's number, cool-under-fire value, mobility value, country affiliation, type of character, and point value. This information will be explained below in a discussion of an embodiment pertaining to a set of rules of play. Other information can be included as well as deleted from the character (play-piece).

Play-pieces can be made to represent characters such as 602 as well as inanimate objects such as a fort, a castle, an underground chamber, machines such as tanks, trucks, etc. Play-pieces can also resemble people (men and women), animals, and fictional characters such as monsters, aliens, etc. There is no limitation with respect to the subject matter of a play-piece. A play-piece can be as simple as a paper card or a piece of plastic, such as a checker.

In one or more embodiments, aspects of the present invention can be applied to customize play-pieces in an existing game; thereby creating a new game. One such existing game is known as “checkers.” A checker or all of the checkers that a player uses during game play can be customized, thereby giving the checkers different attributes or similar attributes. Games of checkers can be replayed with different customizations applied to the checkers on subsequent plays of the game; thereby exploring various customization strategies on game play. Any one of the devices shown in the preceding figures such as the device 200 (FIG. 2A) the device 350 (FIG. 3B) the device 402 (FIG. 4) or the devices 520 or 530 (FIG. 5A) can be used to customize the attributes of the checkers.

FIG. 7A depicts one embodiment of a play surface shown generally at 700 on which customizable play-pieces can be used for game play. In one embodiment, following the battle-game-play theme, game play progresses according to the following overview: pick a mission to play, each side assembles their troops (army), deploy each army (on the play surface), fight a battle to accomplish the objective of the mission, use the victory condition of the mission to determine the outcome of the battle.

Within the battle-game-play theme and the Word War II time era, missions can range in complexity. Some examples of missions are, but are not limited to, a present day Nazi group sends a squad back in time to enable Adolph Hitler to find the “arc of the covenant” during World War II, if successful, thereby allowing Germany to become the present ruler of the world; to counter, an opposing squad is sent back to prevent the Nazi squad from success; patrols; sweeps; all out attacks; raids; defenses of terrain, etc. Missions will vary according to the theme employed for game play as well as the aspects of time travel employed therein.

According to various embodiments, each side can be comprised of a plurality of players or single players can oppose each other during game play. After agreeing on a mission, each side creates an army or a force customized to proceed on the mission. Each army is comprised of a number of play-pieces and each play-piece is customized with a number of units, as previously described, each unit is worth a number of points and each play-piece is worth a number of points. Each side builds their army up to a predefined point value according to their particular desire during customization of the play-pieces.

Side A places its play-pieces on a play surface such as the one shown at 700 in FIG. 7A. For clarity in this description only two play-pieces per side will be described; therefore side A places play-piece 704 and 706 as shown on play surface 702. Side B places its play-pieces 724 ad 726 on play surface 702. According to one set of rules for game play, a “turn” allows all squads on both sides to perform both a mobility action and an attack action. Squads proceed through a turn according to their initiative value which is the summation of the mobility values for each member of the squad. A play-piece's mobility value is indicated on its base.

Play-piece bases can be made to assume any shape and are not limited to the hexagonal (hex) shape shown in the figures. Similarly, a play surface can be an un-quantified surface wherein a measuring device such as a ruler is used to establish a distance to move a play-piece or the play surface can be comprised of squares, hex boxes or other quantification as desired to facilitate measuring distance for movement; the present invention is not limited to the hex boxes shown herein. The play-piece's mobility value indicates the maximum number of hex boxes the play-piece can be moved during a mobility action. If a play-piece (soldier) begins a turn next to an opposing side's play-piece (enemy figure) the soldier must break combat in order to move away. To break combat the targeting die is rolled; a 4, 5, or 6 allows the soldier to move its full mobility value in any direction along the hex boxes; rolling a 1, 2, or 3, the soldier may either stay in the spot it currently occupies, forfeiting its mobility action, or it may move up to its full mobility value but must take 1 unit of damage which allows the opponent to select a unit to be removed from the group of units that comprises the attributes of the soldier.

Soldiers in a squad must end their movement adjacent to another member of their squad unless a unit contains a “special” that permits otherwise. The “special” would be indicated as a symbol on one of the units that compose the attributes of the soldier. All members of a squad who are not engaged in hand-to-hand combat must move back to adjacency with their squad. Soldiers are in adjacency to their squad when they are in hex boxes that share a common border with another squad member. In the example shown in FIG. 7A, soldiers 704 and 706 are adjacent to each other. Soldiers 724 and 726 are not adjacent and must move into adjacency with each other during their turn. After all soldiers in a squad have either performed a mobility action or passed, each squad member must take either a close combat action, a ranged action or pass.

A close combat action represents up-close weapons fire and hand-to-hand combat fighting. A soldier must be in a hex box adjacent to an enemy soldier to make a close combat attack. A close combat action proceeds by rolling two dice and adding the results together. The attacking soldier's attack value (11 in the example of FIG. 4) is added to the sum of the dice roll to form an attack total, the attack total is compared to the enemy soldier's defense value. If the attack total is equal to or greater than the enemy's defense value the attack hits. If the attack total is lower than the defense value, the attack misses and the attack action is spent.

When a close combat attack is successful, damage will be done to the enemy's attributes that are associated with the enemy play-piece. Assuming the attacking soldier's damage value is greater than zero, the soldier's targeting die (red) is used to determine which unit is to be removed first from the enemy's group of units used to customize the enemy play-piece. Successive units are then removed up to a number of units equal to the soldier's damage value (units following the first unit are removed according to the defending player's choosing).

According to an embodiment adapted for play with six sided dice, the method of game play described above requires removing one of six units; the first unit removed is referenced from the top of the column of units. With reference to FIG. 2A, either unit 250, 220, 222, 224, 226 or 228 would be removed depending on the number rolled, i.e., 1 through 6. Other embodiments can be adapted for game play with different dice and with soldiers embodying different ranges of damage values.

Soldiers are taken out of action and removed from the battlefield when all of their units have been removed.

In one embodiment, a ranged combat action represents fighting at a distance with weapons that have a fire range associated with them such as a gun. A soldier cannot make a ranged combat action if the soldier is next to an opposing soldier (enemy). Additionally, a soldier cannot target an enemy if that enemy is next to a friendly play-piece. A soldier must have a nonzero range value to be capable of making a ranged combat attack. The distance that the ranged combat attack can extend is determined by the soldier's range value. The range value is used to count hex boxes in the same manner as hex boxes are used in the mobility action (described above). Counting begins in the hex box adjacent to the attacker and proceeds up to and including the box that the target is located in. In the example of FIG. 7A soldier 704 would need a range value of 6 to launch a ranged combat attack on enemy 724. Ranged combat attacks can be launched in any direction from the attacking soldier. Ranged combat attacks differ from close combat attacks in that the entire enemy squad is targeted rather than the enemy play-piece in the adjacent hex box in the close combat attack. A targeted enemy squad chooses which squad member will defend against the attack. Each soldier in the squad can only defend once per turn. The attack proceeds when the attacker rolls two dice and then adds the roll results together along with the attacker's attack value (in one embodiment, the attack value is the attribute associated with the play piece; 11 in the example of FIG. 4) to form an attack total. The attack total is compared to the defending enemy's total defense value. The total defense value is the sum of the enemy's defense value and modifiers for units and terrain adjustments if applicable. Terrain adjustments will be described in conjunction with FIG. 7B below. If the attack total is equal to or higher than the defense total, the attack hits. If the attack total is lower than the defense total, the attack misses and the ranged combat operation is spent.

When the ranged combat operation is successful, the value showing on the attacking soldiers targeting die (red) is used to determine which of the defending play-piece's units (in one embodiment, counting down from the top of the stack as indicated in FIG. 4) is to be removed first. Successive units are removed or flipped, up to a number of units that is equal to the attacker's damage value. Attacking and defending soldiers can have abilities (in one or more embodiments, “special abilities”) that affect the amount of damage dealt during an attack.

As previously described, color can be used to augment the customization of a play-piece. Additionally, a unit can be a “one-use unit” that is double-sided. In other embodiments a one-use unit need not be double sided. Instead the one-use unit can be provided with an indicator such as a switch and light to indicate that the unit is no longer available for game play. One-use units can be provided with appropriate connections and electronics can be supplied on the unit and the corresponding device, such that upon flipping the unit and reinstalling the unit into the device, a light, such as a red light, lights to signify the unit is no longer available for game play. In another embodiment, the one-use unit and the device can be configured such that the unit cannot be inserted as far into the device in one orientation as in another orientation; thereby signifying the one-use unit is no longer available for game play.

In one embodiment, rules of game play utilize the color green with one-use double-sided units. The one-use unit is activated during game play when the user makes an oral announcement; thereby activating the one-use unit for one action. The one-use unit can be used, for example, in a mobility action, a combat action or during one enemy action. After the one-use unit is used, the user flips the unit over to signify deactivation of the one-use unit. During an attack, if a previously unused one-use unit is the target of the attack, the one-use unit is flipped over. If the same one-use unit is targeted a second time and hit, the one-use unit is removed from the group of units available to determine the attributes of the play-piece. If a one-use unit has already been flipped following its use and the unit is targeted during an attack, the unit is removed from the group.

In one embodiment, override units can be indicated by the color brown. Override units can be double sided or single sided. Override units are activated during game play and are used, in one embodiment, to override all of the units except the unit that sets the identity of the play-piece. When an override unit is activated, only the override unit and the unit used to establish the identity of the play-piece are used to customize the attributes of the play-piece. In one embodiment, an override unit, when activated, provides immunity to the play-piece from penalties and use restrictions that would normally apply. Those of ordinary skill in the art will recognize that many other rules can be constructed to make use of unit color, double-sided unit construction, one-use units, and override units. No limitation is implied by the rules described above.

Some units require a play-piece to perform a ranged combat action in order for the unit to be used.

Special ranged combat actions can be performed; such an action is cover fire. A squad can provide cover fire for another friendly squad if at least one of the soldiers in the squad providing the cover fire can target the enemy squad. This attack does no damage and no attack roll is required. Instead, all of the enemy soldiers targeted by the cover fire receive a −3 modifier for all attack values during the next combat round. The squad that is affected by cover fire should be marked with a token that does not clear until that squad has completed its next action phase.

In one or more embodiments, a token is a marker or some indicator that can be placed on or near the play surface, or near the play-piece. The token embodies some significance for game play. Some examples of tokens are, but are not limited to, a disk, a bullet, a figure, a symbol, etc. Tokens are afforded broad interpretation within this description, no limitation is implied thereto.

In one embodiment, victory is achieved at the end of 50 minutes of game play or when all of one player's soldiers are taken out of action. All of the point values of every soldier taken out of action and all of the opponents' unit point values removed during game play are added up. The side with the most points wins.

In one or more embodiments, terrain templates can be used in conjunction with the play surface shown in FIG. 7A at 702 to add variation and three-dimensional character to the play surface. In one embodiment, three types of terrain are used on the play surface; open terrain, light terrain, and heavy terrain. Open terrain does not hinder a play-piece's mobility or abilities. Examples of open terrain are plains and open roads. Light terrain hinders movement of a play-piece but does not hinder the effectiveness of a weapon. Heavy terrain hinders both movement of a play-piece and the effectiveness of a weapon.

Light terrain increases the cost of mobility therein by a number of additional hex boxes per unit hex box of light terrain traversed. Where normal terrain, would take 1 hex box to enter, light terrain with a rating of 2 would require a count of 2 for a play-piece to traverse one hex box. Terrain modifiers generally are applied when entering terrain and not when leaving terrain.

Heavy terrain normally increases the hex box count for mobility by a count of 2, and modifies the chance to hit the target by lowering the attack value of the play-piece launching the attack. Custom markings are also used to mark heavy terrain accordingly for individual missions. FIG. 7B illustrates one embodiment of terrain templates utilizing heavy terrain, generally at 750. With reference to FIG. 7B, 752 and 758 indicate regions of heavy terrain marked “M:3 R:3.” The “M:3” designation indicates a “count number per hex box” required to traverse one hex box of the indicated terrain. Therefore it will require a count of three to traverse one hex box of heavy terrain within region 752. The second marking “R:3,” indicates a “count number per hex box” to be allocated to a hex box of the indicated terrain when counting hex boxes (or measuring distance) to a target during a range calculation. Such an increase or decrease in range to a target is a terrain adjustment in one embodiment. Alternatively, a terrain adjustment can be applied to a target's defense value, modifying the defense value thereby. In one or more embodiments, terrain templates present different changes to play-piece mobility and target statistics during game play, as described above. Another region of heavy terrain with markings (M:3 R:3) similar to 752 is found at 756. However, heavy terrain region 756 can present an impassable obstacle to a vehicle while allowing soldiers to pass. Heavy terrain region 754 only presents an increase in mobility of 2 as opposed to 3 presented in the other regions of heavy terrain shown in FIG. 7B. Terrain region 754 modifies mobility and range differently as indicated by “M:2” “R:3.”

In one or more embodiments, during the course of game play, play-pieces can be subjected to special tests. One such special test within the context of the battle-game-play theme requires all soldiers in a squad to perform a test (cool-under-fire test) on each turn, when half or more of the squad has been taken out of action and/or the squad has been marked with a token or other test indicator.

In one embodiment, dice are rolled and the result is compared to a test number (cool-under-fire number) associated with the play-piece. A dice roll equal to or greater than the test number allows the squad to pass the test, a dice roll lower than the test number results in a failed test. If the squad fails the test, each soldier moves a number of boxes equal to the individual soldier's mobility value. The direction of movement will be determined by the direction arrow hex located on the play surface. If a soldier's movement takes it off the battle field (play surface) it is considered lost behind enemy lines and is taken out of action. If a soldier's movement is blocked by either a region of terrain through which it cannot pass or an enemy play-piece, then its movement ends. If the soldier's movement would take the soldier into a hex box occupied by a friendly play-piece then the soldier's movement ceases. Further implications of a failed test result in the squad taking a pass on its upcoming combat action; therefore the squad cannot attack.

With reference back to FIG. 7A, play-pieces from multiple time eras can be in play on the same play surface working in concert to accomplish a mission. For example, a soldier with a laser weapon could be indicated at 704 (FIG. 7A) facing a knight from Camelot at 724 (FIG. 7A). Point cost for the play-pieces can be adjusted according to different embodiments. For example, in each play-piece's respective time era their point costs are the same 35 point. One embodiment will adjust the point cost of the laser to 70 and the point cost of the knight to 15. This adjusted point cost could be chosen if the knight had more accessories or a larger group of friendly play-pieces available. Different point cost adjustments are possible to allow play-pieces from different time eras to interact on the same play surface.

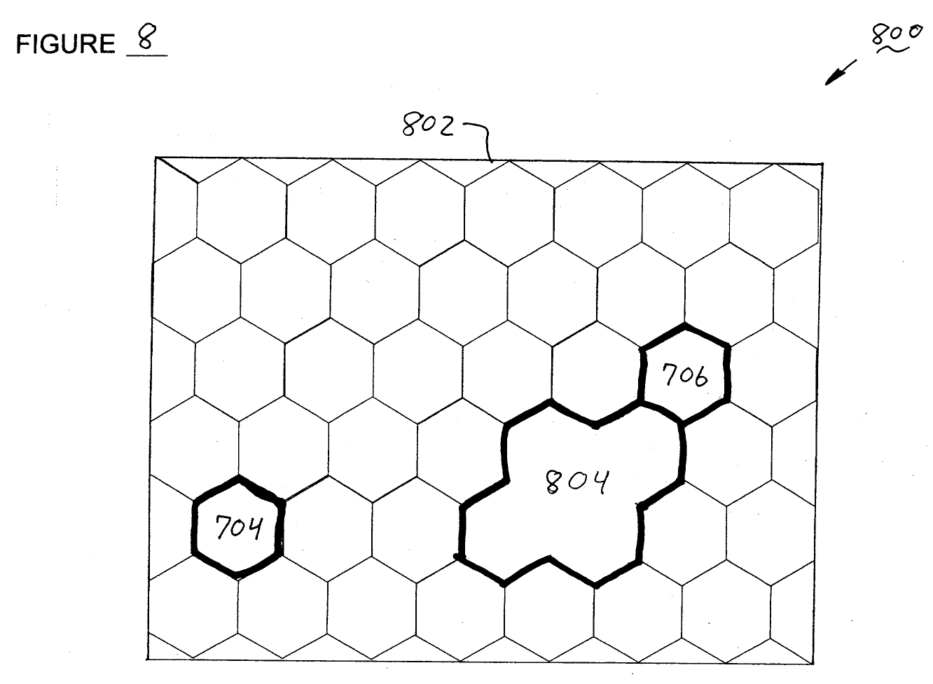

FIG. 8 illustrates one embodiment of parallel time eras on a play surface, generally at 800. With reference to FIG. 8, two time eras are present simultaneously on play surface 802. A first time era exists on the play surface 802, except for the region indicated by the bold line around the hex boxes signified by numeral 804, within 804, a different time era exists. Play-pieces that pass into the hex boxes contained within 804 pass into a time anomaly. Various changes in play-piece attributes can occur when a play-piece enters a time anomaly according to various rules applied to game play. For example, the play-piece can experience a transformation of attributes as long as the play-piece remains within the region 804. The time era represented by 804 can remain stable or it can change according to values occurring during dice rolls taken by the play-piece remaining inside of region 804.

FIG. 9 illustrates another embodiment for customization of a play-piece. With reference to FIG. 9, a play-piece configured to automatically combine indicia from the individual units is shown generally, at 900. A play-piece can be configured with a reader 906, a data processor indicated by 908, and a display 904. A unit 910 is placed within range of the reader 906 to temporarily spatially proximately group the unit 910 and the reader 906 to facilitate reading the contribution to the play-piece's attributes contained within the unit 910. The degree of proximate grouping depends on the method used to transfer data between the unit and the reader. The reader 906 and unit 910 can interact according to any of a variety of ways that are well known in the art, such as magnetic strip, optical scanning, wireless communication, etc. After a number of units have been selected by a user and swiped past the reader 906, the play-piece 902 is customized by the user. In one embodiment, the magnitude of the attributes can be displayed on the display 904. When damage is inflicted on a play-piece the appropriate unit can be reread by the reader to remove the contribution of the attribute from the play-piece's original customization.

FIG. 10 illustrates an electronic play surface generally at 1000. With reference to FIG. 10, a play surface 1010 can be an information display similar to a computer monitor or television screen. A play-piece indicated by 1012 can be customized by using a reader 1014 and a unit 1020. As described in conjunction with FIG. 9, the unit 1020 can be read by a reader 1014 to associate attributes with the play-piece 1012. A number of units can be read by the reader 1014 to allow the user to customize the play-piece 1012. The attributes to be associated with the play-piece after customization can be displayed on the electronic play surface as indicated at 1013. Alternatively, a display can be provided as shown at 1016 either separate from or incorporated into a housing 1015 configured to hold the reader 1014. The reader 1014 can be configured to pass data to the play surface for display on the play surface. Additionally, controls to move the play-piece around on the play surface 1010 can be provided in the form of a mouse or a touch screen can be built into the play surface 1010.

In one or more embodiments, the customizable game described herein can be configured for game play between one or more players using a network to facilitate communication between players. Some examples of networks are, but are not limited to, a local area network, an intranet or the Internet. Networks can be wireless or wired. Users or players of the game can participate in game play by paying a credit for a copy of the game; a period of game play time; a single game play session; game play that continues up to the accumulation of a predefined number of points, etc. A debit can be assed by a game host who, in one embodiment, charges the users for game play.

It will be appreciated that the methods described in conjunction with the figures may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall, accordingly, be taken to include, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

As used in this description, “one embodiment,” “one or more embodiments,” “an embodiment” or similar phrases means that feature(s) being described are included in at least one embodiment of the invention. References to “one embodiment” or any reference to an embodiment in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a device; and
a play-piece wherein the device is to enable a user to customize an attribute of the play-piece wherein the play-piece is to be used by the user in game play.

2. The apparatus as in claim 1, wherein the play-piece can be moved independently from the device by the user in game play.

3. The apparatus as in claim 1, wherein the play-piece is selected from the group consisting of a miniature character, an inanimate object, a monster, an alien, a tank, a dinosaur, a man, a woman, an animal, a fictional character, and a machine.

4. The apparatus as in claim 1, wherein the device is selected from the group consisting of a box, a flexible member, a rope, a string, a chain, a unit dispenser, a card sleeve, a tray, and a rack.

5. The apparatus as in claim 1, wherein the device is a box configured to hold at least one unit, the unit containing an indicium displayed on the unit, the indicium corresponding to the attribute to be associated with the play-piece wherein the user customizes the attribute associated with the play-piece.

6. The apparatus as in claim 5, wherein the attribute is selected from the group consisting of a range value, a damage value, an attack value, a defense value, and a special ability.

7. The apparatus as in claim 6, wherein the box is configured to proximately arrange seven units wherein indicia from the units combine to establish a customized attribute to be associated with the play-piece.

8. The apparatus as in claim 7, wherein one of the seven units is an identification unit for the play-piece.

9. The apparatus as in claim 7, wherein the box is configured to hold five groups of units, each group of units corresponding to a different play-piece.

10. The apparatus as in claim 1, wherein the device is a tray configured to hold at least one unit, the unit containing an indicium displayed on a surface of the unit, the indicium corresponding to the attribute to be associated with the play-piece wherein the user customizes the attribute associated with the play-piece.

11. The apparatus as in claim 10, wherein the attribute is selected from the group consisting of a range value, a damage value, an attack value, a defense value, and a special ability.

12. The apparatus as in claim 11, wherein the tray is configured to proximately arrange seven units wherein indicia from the units combine to establish a customized attribute to be associated with the play-piece.

13. The apparatus as in claim 11, wherein one of the seven units is an identification unit for the play-piece.

14. The apparatus as in claim 12, wherein the tray is configured to hold five columns of units, each column corresponding to a different play-piece.

15. The apparatus as in claim 1, wherein the device is a unit dispenser configured to hold at least one unit, the unit containing an indicium displayed on the unit, the indicium corresponding to the attribute to be associated with the play-piece wherein the user customizes the attribute associated with the play-piece.

16. The apparatus as in claim 15, wherein the attribute is selected from the group consisting of a range value, a damage value, an attack value, a defense value, and a special ability.

17. The apparatus as in claim 16, wherein the unit dispenser is configured to proximately arrange seven units wherein the indicia from the units combine to establish a customized attribute to be associated with the play-piece.

18. The apparatus as in claim 17, wherein one of the seven units is an identification unit for the play-piece.

19. The apparatus as in claim 17, wherein the unit dispenser is configured to hold five groups of units, each group corresponding to a different play-piece.

20. The apparatus as in claim 1, wherein the device is a flexible member configured to hold at least one unit, the unit containing an indicium displayed on a surface of the unit, the indicium corresponding to the attribute to be associated with the play-piece wherein the user customizes the attribute associated with the play-piece.

21. The apparatus as in claim 20, wherein the attribute is selected from the group consisting of a range value, a damage value, an attack value, a defense value, and a special ability.

22. The apparatus as in claim 21, wherein the flexible member is configured to proximately arrange seven units wherein the indicia from the units combine to establish a customized attribute to be associated with the play-piece.

23. The apparatus as in claim 22, wherein one of the seven units is an identification unit for the play-piece.

24. The apparatus as in claim 22, wherein a second flexible member is configured to receive the flexible member and the seven units, each flexible member of seven units corresponding to a different play-piece.

25. The apparatus of claim 1, further comprising:
a reader configured to read data from a unit, the data corresponding to the attribute to be associated with the play-piece;
a processor configured to mathematically manipulate the data; and
an information display configured to receive the data from the processor and to display the data, wherein the attribute associated with the play-piece is customized by the user.

26. The apparatus as in claim 25, wherein the information display is located on the play-piece.

27. The apparatus as in claim 25, wherein the information display is at least a part of a play surface used in game play.

28. The apparatus as in claim 1, wherein the apparatus is capable of transferring a debit or a credit.

29. An apparatus comprising:
a first unit having a first indicium corresponding to an attribute associated with a play-piece; and
a second unit having a second indicium corresponding to the attribute associated with the play-piece, wherein the first unit is grouped with the second unit, and the first indicium and the second indicium are capable of being mathematically combined to customize the attribute associated with the play-piece to be used to play a game.

30. The apparatus of claim 29, wherein the first unit is selected from a first set, the first unit to identify the play-piece.

31. The apparatus of claim 29, further comprising:
one or more play-piece rarity levels wherein the play-piece is associated with the one or more play-piece rarity levels.

32. The apparatus of claim 29, wherein the second unit is selected from a second set.

33. The apparatus of claim 29, further comprising:
one or more unit rarity levels wherein a unit is associated with one or more unit rarity level.

34. The apparatus as in claim 29, wherein the first unit is grouped with the second unit using a device selected from the group consisting of a box, a flexible member, a rope, a string, a chain, a unit dispenser, a card sleeve, a tray, and a rack.

35. The apparatus as in claim 34, wherein the first indicium and the second indicium are capable of being mathematically combined by the user.

36. The apparatus as in claim 29, wherein the first unit is capable of being temporarily spatially proximately grouped with the second unit.

37. The apparatus as in claim 36, wherein the first indicium and the second indicium are capable of being electronically combined.

38. The apparatus as in claim 37, further comprising:
a processor; and
a reader configured to communicate with the processor wherein the reader is capable of reading the first indicium and the second indicium and the processor is capable of mathematically combining the first indicium and the second indicium wherein the attribute associated with the play-piece is to be customized by the user.

39. The apparatus of claim 29, wherein the first unit is selected from the group consisting of a tag, a computer chip, a paper card, a credit card, and a coin.

40. The apparatus of claim 29, wherein the second unit is selected from the group consisting of a tag, a computer chip, a paper card, a credit card, and a coin.

41. The apparatus of claim 29, wherein the first unit contributes to the attribute selected from the group consisting of a range value, a damage value, an attack value, a defense value, a tactic, a piece of equipment, a skill, an order, a weapon, and an identity of the play-piece.

42. The apparatus of claim 29, wherein the second unit contributes to the attribute selected from the group consisting of a range value, a damage value, an attack value, a defense value, a tactic, a piece of equipment, a skill, an order, a weapon, and an identity of the play-piece.

43. The apparatus as in claim 29, wherein the play-piece is selected from the group consisting of a miniature character, an inanimate object, a monster, an alien, a tank, a dinosaur, a man, a woman, an animal, a fictional character, and a machine.

44. The apparatus as in claim 29, wherein the apparatus is capable of transferring a debit or a credit.

45. An apparatus comprising:
a first play-piece from a first time era, the first play-piece having a first point value; and
a second play-piece from a second time era, the second play-piece having a second point value wherein a game is capable of being played between the first play-piece and the second play piece.

46. The apparatus as in claim 45, wherein the first point value is associated with the first time era and the second point value is associated with the second time era.

47. The apparatus as in claim 45, wherein a point value of any play-piece can change.

48. The apparatus as in claim 45, wherein the first time era is capable of changing to a different time era.

49. The apparatus as in claim 45, wherein the second time era changes to a different time era.

50. The apparatus as in claim 45, wherein any play-piece is selected from the group consisting of a miniature character, an inanimate object, a monster, an alien, a tank, a dinosaur, a man, a woman, an animal, a fictional character, and a machine.

51. An apparatus comprising:
rules of game play;
a unit belonging to an opponent during a game;
a play-piece belonging to the opponent, wherein the unit is to provide an attribute associated with the play-piece; and
a game move wherein the unit is capable of being removed from the opponent's possession and the play-piece is capable of loosing the attribute associated with the unit wherein points can be scored.

52. The apparatus as in claim 51, wherein more than one time era is associated with the game.

53. The apparatus as in claim 51, wherein the apparatus is capable of transferring a debit or a credit.

54. A method for playing a game comprising:
selecting a first unit to specify a play-piece the first unit to specify a first indicium of an attribute of a play-piece;
selecting a second unit, the second unit to specify a second indicium of the attribute; and
combining the first indicium and the second indicium to customize the attribute of the play-piece.

55. A method as in claim 54, further comprising:
removing a unit during game play wherein the play-piece looses an attribute associated with the unit and points are scored.

56. The method of claim 54, further comprising:
transferring a debit or a credit.

57. A computer readable medium containing executable computer program instructions, which when executed by a data processing system, cause the data processing system to perform a method comprising:
selecting a first unit to specify a play-piece the unit to specify a first indicium of an attribute of a play-piece;
selecting a second unit, the second unit to specify a second indicium of the attribute; and
combining the first indicium and the second indicium to customize the attribute of the play-piece.

58. The computer readable medium as set forth in claim 57, the method further comprising:
removing a unit during game play wherein the play-piece loses an attribute associated with the unit and points are scored.

59. The computer readable medium of claim 57, the method further comprising:
transferring a debit or a credit.

60. An apparatus comprising:
a processor;
a reader coupled with the processor; and
a computer readable medium containing executable computer program instructions, which when executed by the apparatus, cause the apparatus to perform a method:
reading a first unit to specify a play-piece the unit to specify a first indicium of an attribute of a play-piece;
reading a second unit, the second unit to specify a second indicium of the attribute; and
combining the first indicium and the second indicium to customize the attribute of the play-piece.

61. The apparatus of claim 60, further comprising:
an information display coupled with the processor to display the customized attribute of the play-piece.

62. The apparatus of claim 60, the method of the computer readable medium further comprising:
transferring a debit or a credit.

63. An apparatus comprising:
a means for customizing a play-piece;
a means for moving the play-piece during game play;
a means for scoring points during game play; and
a means for doing damage to an opponent's play-piece during game play wherein the customization of the play-piece is altered.

64. The apparatus as in claim 63, further comprising:
a means for applying more than one time era to a game during game play.

65. An apparatus comprising:
a play surface, wherein the play surface is capable of allowing a play-piece to move a first distance and the play surface is capable of allowing the play-piece to interact with a second play-piece, the second play-piece is to be a second distance from the play-piece wherein the first distance and the second distance are to be different.

66. The apparatus of claim 65, wherein the interaction is a targeting action.

67. An apparatus for game play, comprising:
a unit, wherein the unit is configured to associate an attribute with a play-piece when the unit is activated.

68. The apparatus of claim 67, wherein the unit is capable of being activated by moving the unit from a first position to a second position.

69. The apparatus of claim 68, wherein moving is selected from the group consisting of flipping, rotating, tapping, and moving the unit into or out of a device.

70. The apparatus of claim 67, wherein the unit is capable of being deactivated by moving the unit from the second position to a third position.

71. The apparatus of claim 67, wherein a color on the unit is used to indicate the attribute.

72. The apparatus of claim 67, wherein a color of at least a part of the unit is used to indicate that the unit is capable of being deactivated.

73. The apparatus of claim 67, wherein a color of at least a part of the unit is used to indicate a state wherein the state is selected from the group consisting of activated and deactivated.

74. A method of game play comprising:
associating a unit with a play-piece, the unit is to associate an attribute with the play-piece when the unit is activated.

75. The method of claim 74, further comprising:
activating the unit for game play.

76. The method of claim 75, wherein the activating occurs by moving the unit from a first position to a second position.

77. The method of claim 76, wherein moving is selected from the group consisting of flipping, rotating, tapping, and moving the unit into or out of a device.

78. The method of claim 76, wherein the unit is flipped by moving the unit from the first position to the second position.

79. The method of claim 75, wherein the activating changes a color of at least a part of the unit.

80. The method of claim 75, wherein a color of at least a part of the unit indicates whether the unit needs to be activated.

81. The method of claim 74, further comprising:
deactivating the unit for game play, wherein the attribute is disassociated from the play-piece.

82. The method of claim 81, wherein the deactivating occurs by moving the unit from the second position to a third position.

83. The method of claim 82, wherein moving is selected from the group consisting of flipping, rotating, tapping, and moving the unit into or out of a device.

84. The method of claim 82, wherein the unit is flipped by moving from the second position to the third position.
